(19) United States
(12) Patent Application Publication
(10) Pub. No.: US 2015/0321748 A1
(43) Pub. Date: Nov. 12, 2015

(54) SPEED BRAKE ALERTING SYSTEM AND METHOD

(71) Applicant: HONEYWELL INTERNATIONAL INC., Morristown, NJ (US)

(72) Inventors: Steve Johnson, North Bend, WA (US); Yasuo Ishihara, Kirkland, WA (US); Kevin J. Conner, Kent, WA (US)

(73) Assignee: HONEYWELL INTERNATIONAL INC., Morristown, NJ (US)

(21) Appl. No.: 14/272,738

(22) Filed: May 8, 2014

(51) Int. Cl. B64C 9/32; B64D 45/00

(52) U.S. Cl. CPC B64C 9/323; B64D 45/00

(57) ABSTRACT

A system and method is provided for controlling the speed of an aircraft with a speed brake during landing. The system includes a speed brake control system and a speed brake controller coupled to the speed brake control system for arming the speed brake. An alert generator is coupled to the speed brake controller for generating an alert when the speed brake is not armed.

### TECHNICAL FIELD

The present invention generally relates to aircraft braking systems and methods, and more particularly, to systems and methods for generating signals indicative of the state of an aircraft's speed brakes.

### BACKGROUND

Modern commercial aircraft make extensive use of complex systems for controlling aircraft and managing aircraft operations. For example, such systems may include a flight management system (FMS) that generates flight plans with lateral segments and vertical segments to a landing destination. The flight plans may include details related to the ascent, cruise, descent, and landing modes of a flight. This includes the appropriate use of the aircraft's speed brakes. To suitably understand this, however, it is important to understand what is meant by the terms “speed brake” and “spoiler” since they are often used interchangeably. Simply stated, both employ the same components comprising panels (i.e. spoilers) whose trailing edge is forced upwards (typically using hydraulics) into the airflow passing over the top surface of a wing. The difference resides in the function being performed and the degree to which they are deployed. For example, during descent, the panels may be deployed to, for example, thirty degrees to achieve a steeper descent at the same speed. In this case, the panels may be referred to as “spoilers”. During landing, or just prior to touchdown, however, the panels may automatically deploy to as much as sixty degrees to reduce aircraft lift. In this scenario, the panels are commonly referred to as “speed brakes” or “speed brake” and will hereinafter be referred to as such.

As already alluded to, the speed brake plays an important role during the landing process. For example, one of the primary causes of runway overrun is the failure to employ all available stopping devices during landing. However, the speed brake must first be armed, as failure to do so may result in the failure of the speed brake to automatically deploy. Thus, it is important to assure that the speed brake is properly armed. To this end, certain aircraft are equipped with systems that alert the pilot on touchdown that the speed brake has not deployed. Also, some aircraft are equipped to provide a visual alert when the speed brake is armed prior to landing. Unfortunately, the former alert occurs late in the landing process, while the latter occurs earlier, but is a somewhat passive and may not receive appropriate and timely attention in a busy cockpit environment.

In view of the foregoing, it would be desirable to provide improved systems and methods for alerting a flight-crew that the speed brake has not been armed. Furthermore, other desirable features and characteristics of the present invention will become apparent from the subsequent detailed description of the invention and the appended claims, taken in conjunction with the accompanying drawings and this background of the invention.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In accordance with an exemplary embodiment, a system is provided for reducing aircraft lift with a speed brake during landing. The system includes a speed brake control system and a speed brake controller coupled to the speed brake control system for arming the speed brake. An alert generator is coupled to the speed brake controller for generating an alert when the speed brake is not armed.

In accordance with another exemplary embodiment, a method is provided for reducing aircraft lift using a speed brake during landing. The method comprises generating an alert on board the aircraft prior to landing when the speed brake is not armed.

### BRIEF DESCRIPTION OF THE DRAWINGS

Embodiments of the subject matter will hereinafter be described in conjunction with the following drawing figures, wherein like numerals denote like elements, and

FIG. 1 is an isometric view of an aircraft illustrating the location and function of various aircraft control surfaces including the components that comprise an aircraft speed brake;

FIG. 2 is an isometric view of and aircraft wing with a deployed speed brake; and

FIG. 3 is a block diagram of a flight deck control system in accordance with an exemplary embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, i.e. memory elements, digital signal processing elements, logic elements, look-up tables, or the like, which may carry out a variety of functions under the control of one or more microprocessors or other control devices.

The following description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

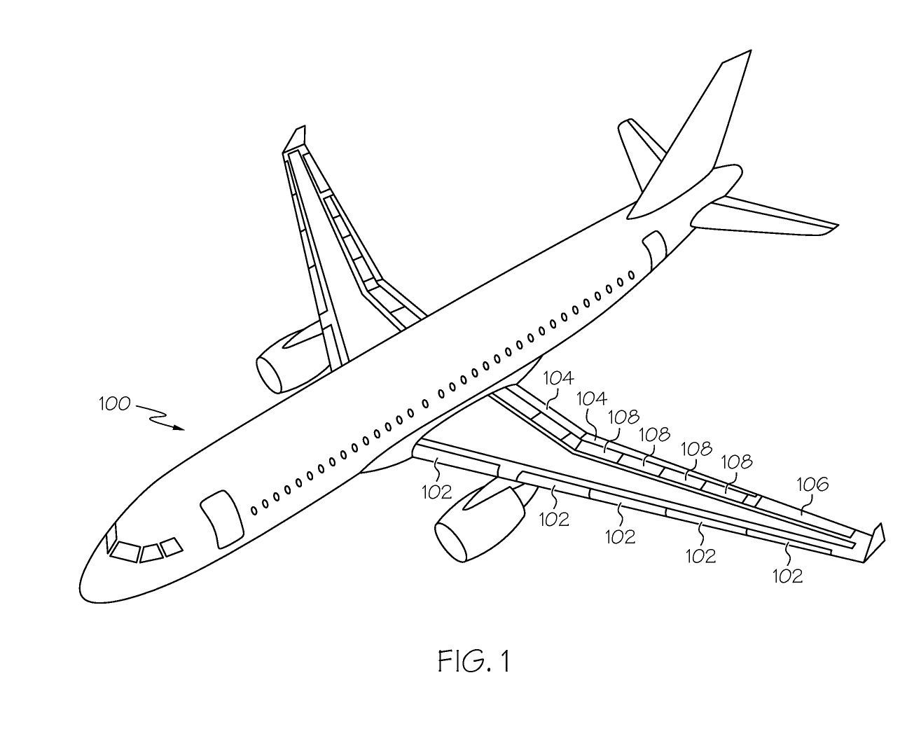

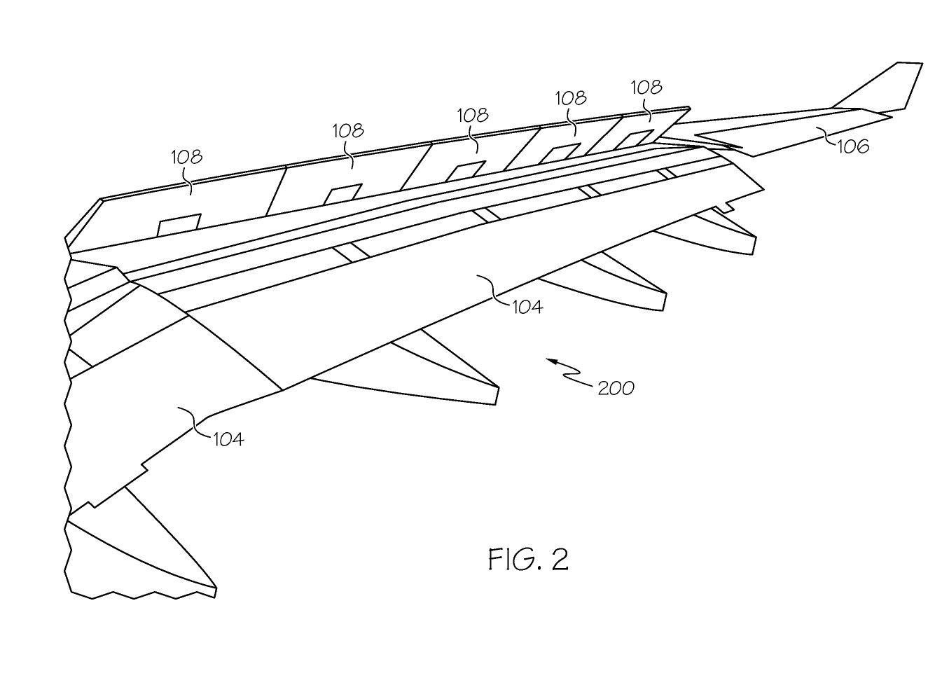

FIG. 1 depicts an aircraft 100 including a plurality of flight control surfaces. For example, the leading edge of each wing includes a plurality of slats 102 which, when deployed, allow the wing to operate at a higher angle of attack producing a higher coefficient of lift. Thus, the aircraft can fly at slower speeds or take off and land in shorter distances. Flaps 104, mounted on the trailing edges of a wing, improve the wing's lift characteristics. An aileron 106 is a hinged flight control surface usually attached to the trailing edge of each wing and is used in pairs to control the aircraft in roll (around the aircraft's longitudinal axis), which normally results in a change in heading due to the tilting of the lift vector. And of primary concern herein, speed brakes (or spoilers) 108, when used symmetrically on both sides of the aircraft, are used to reduce lift on the wings to achieve a high level of braking. FIG. 2 illustrates an aircraft wing 200 equipped with speed brakes 108 deployed for landing.

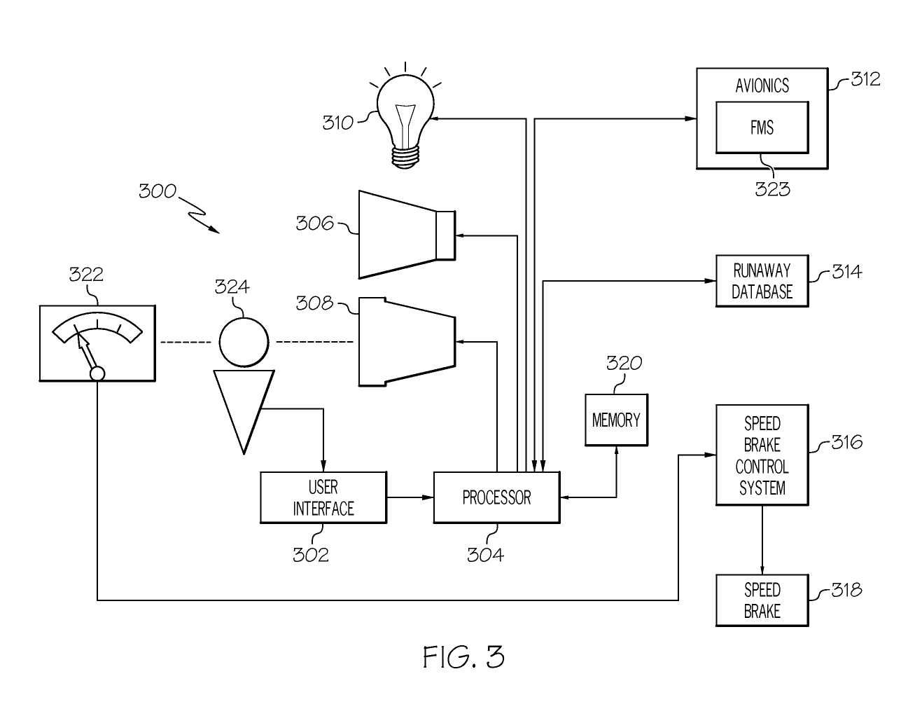

FIG. 3 is a block diagram depicting an exemplary flight deck display system 300 (suitable for a vehicle such as an aircraft) that generally includes, without limitation: a user interface 302; a processor 304 coupled to the user interface 302; an aural annunciator 306; a display element 308; and a visual indicator 310. The system 300 may also include, cooperate with, and/or communicate with a number of databases, sources of data, or the like. Moreover, the system 300 may include, cooperate with, and/or communicate with a number of external subsystems as described in more detail below. For example, the processor 304 may cooperate with one or more of the following components, features, data sources, and subsystems, without limitation: a runway database 314; a speed brake control system 316; a speed brake 318; and a manual speed brake actuator 322 (e.g., a lever).

The runway database 314 includes various types of data, including runway location, runway bearing, and runway length. Although the runway database 314 is, for clarity and convenience, shown as being stored separate from processor 304, all or portions of this database 314 could be loaded into the onboard RAM, stored in ROM, or integrally formed as part of the processor 304. Runway database 314 could also be part of a device or system that is physically separate from system 300.

The user interface 302 is in operable communication with the processor 304 and is configured to receive input from a user 324 (e.g., a crew-member) and, in response to the user input, supply command signals to the processor 304. The user interface 302 may be any one, or combination, of various known user interface devices including, but not limited to, a cursor control device (CCD), such as a mouse, a trackball, or joystick, one or more buttons, switches, or knobs. The user 324 manipulates the user interface 302 to, among other things, move cursor symbols that might be rendered at various times on the display element 308 and to input textual data. As depicted in FIG. 3, the user interface 302 may also be utilized to enable user interaction with avionics system 312 which may include a Flight Management System (FMS) 323 and/or other features and components of the aircraft. A speed brake 318 may be deployed upon receipt of an actuating signal from a speed brake control system 322 (e.g., a lever) operated by a crew-member 324.

The processor 304 may utilize one or more known general-purpose microprocessors or an application specific processor that operates in response to program instructions. In the depicted embodiment, the processor 304 includes or communicates with onboard memory 320. The program instructions that control the processor 304 may be stored in RAM and/or ROM in memory 320. It will be appreciated that this is merely exemplary of one scheme for storing operating system software and software routines, and that various other storage schemes may be implemented. It will also be appreciated that the processor 304 may be implemented using various other circuits, not just a programmable processor. For example, digital logic circuits and analog signal processing circuits could also be used.

Notably, it should be understood that although system 300 appears in FIG. 3 to be arranged as an integrated system, the exemplary embodiments are not so limited and can also include an arrangement whereby one or more of the components are separate components or subcomponents of another system located either onboard or external to an aircraft. Furthermore, the systems and methods are not limited to manned aircraft and can also be implemented for other types of vehicles, such as, for example, spacecraft or unmanned vehicles.

The processor 304 is in operable communication with user interface 302, aural annunciator 306, display element 308, visual annunciator 310 and runway database 314 and is coupled to receive various types of data, information, commands, signals, etc., from the various sensors, data sources, instruments, and subsystems described herein.

In certain embodiments, the processor 304 is configured to respond to data obtained by the onboard sensors to selectively retrieve data from the runway database 314. The processor 304 also provides appropriate commands to aural annunciator 306 and visual alert 310 as will be described hereinafter. The processor 304 may be further configured to receive real-time (or virtually real-time) airspeed, altitude, attitude, and/or geographic position data for the aircraft.

Position determining systems are suitably configured to obtain geographic position data for the aircraft. The geographic position data obtained may represent the latitude and longitude of the aircraft in an ongoing and continuously updated manner. In general, an avionics suite 312 determines the current kinematic state of the aircraft and may include any suitable position and direction determination devices, such as an inertial reference system (IRS), an air-data heading reference system (AHRS), or a global navigation satellite system (GNSS). For example, the avionics suite 312 provides at least the current position and velocity of the aircraft to a speed brake alerting system. Other aircraft state information may include the current heading, current course, current track, altitude, pitch, and any desired flight information. Global positioning system (GPS) technologies are commonly deployed in avionics applications as a source of aircraft position data.

The user interface 302 may include any suitable hardware and software components that enable the pilot to interface with the system 300. As particularly shown, a user has access to a speed brake control interface 322 that enables the pilot to engage the speed brake control system 316 directly.

The speed brake control interface 322 is typically a lever that may be pivoted from a first or “not armed” position. From there the lever may be lifted and pivoted to an “armed” position. Finally, the lever may be moved from the armed position to a fully deployed position. Accordingly, the position of the speed brake control interface 322 enables the pilot to apply a selected amount of braking (i.e., drag) to the aircraft. The speed brake control system 316 may provide the speed brake recommendation to display unit 308 for display thereon.

As stated previously, some aircraft are equipped with systems that provide a visual alert when the speed brake is armed prior to landing. However, in accordance with an exemplary embodiment, a system is provided that generates an alert when the speed brake is not armed. Referring again to FIG. 3, processor 304 monitors the state of speed brake 318. When speed brake 318 is not armed, indicator light 310 is illuminated calling attention to the fact that the speed brake is not armed. The indicator may comprise, for example, a lamp just above the navigation display and/or a text message or symbology on a cockpit system such as the Engine Indicating and Crew Alerting System (EICAS). Also, an audible alert may be generated by annunciator 306, at a predetermined time prior to landing, at a predetermined altitude above the runway, and/or at a predetermined distance from the runway, if the speed brake has not been armed.

By generating an alert, aural and/or visual, constant or intermittent, when the speed brake is not armed, it is more likely that the status of the speed brake will be observed by a crew-member. Thus, there has been provided an improved system and method for alerting a flight-crew prior to landing that the speed brake has not been armed.

It is important to note that while exemplary embodiments have been described in the context of a fully functioning aircraft system, exemplary embodiments are further capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for reducing aircraft lift during landing, the system comprising:
a speed brake control system;
a speed brake controller coupled to the speed brake control system for arming the speed brake; and
an alert generator coupled to the speed brake controller for generating an alert when the speed brake is not armed.

2. The system of claim 1, further comprising a processor coupled to the speed brake control system and coupled to the alert generator for activating the alert when the speed brake is not armed.

3. The system of claim 2, wherein the alert is a visual alert.

4. The system of claim 3, wherein the visual alert comprises a lamp.

5. The system of claim 3, wherein the visual alert comprises a display.

6. The system of claim 2, further comprising a runway database coupled to the processor.

7. The system of claim 6, further comprising an avionics suite coupled to the processor.

8. The system of claim 3, wherein the visual alert is a blinking alert.

9. The system of claim 1, wherein the alert is audible.

10. The system of claim 9 wherein the audible alert is intermittent.

11. A method for controlling the speed of an aircraft with a speed brake during landing, comprising generating an alert on board the aircraft prior to landing when the speed brake is not armed.

12. The method of claim 11, wherein the step of generating comprises generating a visual alert.

13. The method of claim 11, wherein the step of generating comprises generating an audible alert.

14. The method of claim 12, wherein the step of generating comprises generating an intermittent alert.

15. The method of claim 12, further comprising the step of rendering symbology on a display graphically representing that the speed brake is not armed.

16. A method for controlling the speed of an aircraft with a speed brake during landing, comprising generating at least one of a visual alert and an audible alert on board the aircraft prior to landing when the speed brake is not armed.

17. The method of claim 16 wherein the step of generating a visual alert comprises rendering symbology on a display prior to landing graphically representing that the speed brake is not armed.

18. The method of claim 16, wherein the step of displaying comprises activating a lamp prior to landing.

19. The method of claim 16, wherein the at least one alert is intermittent.
